(19) United States
(12) Patent Application Publication
(10) Pub. No.: US 2015/0185380 A1
(43) Pub. Date: Jul. 2, 2015

(54) Color Filter Arrays, And Image Sensors And Display Devices Including Color Filter Arrays

(71) Applicant: Samsung Electronics Co., Ltd., Suwon-si (KR)

(72) Inventor: Naoyuki Miyashita, Hwaseong-si (KR)

(21) Appl. No.: 14/503,934

(22) Filed: Oct. 1, 2014

(30) Foreign Application Priority Data
Dec. 27, 2013 (KR) 10-2013-0165548

(51) Int. Cl. G02B 5/20; G02B 5/22; H04N 9/64

(52) U.S. Cl. CPC G02B 5/201; H04N 9/646; G02B 5/22

(57) ABSTRACT

A color filter array, an image sensor including a color filter array, and a display device including a color filter array are disclosed. In the color filter array, color filters are configured in such a way that, for light corresponding to its own color, each of the color filters has a refractive index that is higher than the refractive indices of other ones of the color filters that pass different colors.

### CROSS-REFERENCE TO RELATED APPLICATIONS

This U.S. non-provisional patent application claims priority under 35 U.S.C. §119 to Korean Patent Application No. 10-2013-0165548, filed on Dec. 27, 2013, in the Korean Intellectual Property Office, the disclosure of which is hereby incorporated by reference.

### BACKGROUND

Example embodiments of the inventive concept provide a color filter array, an image sensor therewith, and a display device therewith.

In the fabrication of image sensors, such as typical CMOS image sensors, transistors are formed on a semiconductor substrate in which a photodiode is formed for each pixel, and multi-layered metal interconnections and interlayer dielectrics are formed on the transistor. Color filters and microlenses are also formed on the interlayer dielectrics. In an image sensor having such a structure, light collected by the microlens passes through the interlayer dielectric layers until it reaches a photodiode. As the light passes through the interlayer dielectric layers, it may be reflected, scattered and/or blocked by the metal interconnections at a plurality of levels, which may reduce the light condensing efficiency of a pixel. Thus, the image quality may be reduced. To overcome these limitations, backside-illuminated image sensors have been proposed that receive light through the back side of the device. However, the performance of backside-illuminated image sensors may be limited due to crosstalk between pixels caused by the diffraction of light. Crosstalk may increase as the wavelength of light increases and as the integration level of the image sensor is increased.

### SUMMARY

Some embodiments of the inventive concept provide a color filter array that may reduce undesired optical effects (e.g., diffraction).

Other embodiments of the inventive concept provide an image sensor configured to reduce cross-talk between neighboring pixels.

Still other embodiments of the inventive concept provide a display device capable of providing a clear image quality.

According to some embodiments of the inventive concept, a color filter array includes a plurality of color filters, each of which is configured to pass a respective color of light and has a refractive index for light of the respective color it passes that is higher than refractive indices of adjacent ones of the color filters for light of the respective color.

In some embodiments, the color filters may have substantially the same refractive index in a wavelength range corresponding to infrared light.

In some embodiments, each of the color filters may have a refractive index of about 1.8 or higher, in a wavelength range corresponding to its own color.

In example embodiments, the color filters contain at least one of zinc sulfide (ZnS), titanium oxide (TiO₂), zinc oxide (ZnO), or zirconium oxide (ZrO2).

As an example of the color filter array, a color filter array may include a first color filter of a first color, a second color filter of a second color, and a third color filter of a third color. Here, in a wavelength range corresponding to the first color, the first color filter may have a refractive index that is higher than those of the second and third color filters.

In some embodiments, in a wavelength range corresponding to the second color, the second color filter may have a refractive index that may be higher than those of the first and third color filters.

In some embodiments, in a wavelength range corresponding to the third color, the third color filter may have a refractive index that may be higher than those of the first and second color filters.

In some embodiments, in a wavelength range of infrared, the first, second, and third color filters may have substantially the same refractive index.

According to other example embodiments of the inventive concept, an image sensor may include the color filter array, and photoelectric conversion parts, which are provided below the color filter array, and each of which is located to face a corresponding one of the color filters.

In some embodiments, the image sensor may further include an interlayered insulating layer and interconnection lines provided below the photoelectric conversion parts.

In some embodiments, the image sensor may further include an interlayered insulating layer and interconnection lines provided between the color filter array and the photoelectric conversion parts.

In some embodiments, the image sensor may further include a micro lens array provided on the color filter array.

According to still other embodiments of the inventive concept, a display device may include a light source, a thin-film transistor substrate on the light source, the color filter array provided on the thin-film transistor substrate, and a display layer provided between the color filter array and the thin-film transistor substrate.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a plan view illustrating a color filter array according to embodiments of the inventive concept.

FIG. 2 is a graph showing refractive index characteristics of color filters over a wavelength of light, according to embodiments of the inventive concept.

FIG. 2A is a sectional view of a pair of color filters in a color filter array according to some embodiments of the inventive concept.

FIG. 3 is a circuit diagram of an image sensor according to embodiments of the inventive concept.

FIG. 4 is a sectional view of an image sensor according to embodiments of the inventive concept.

FIG. 5 is a sectional view of an image sensor according to other embodiments of the inventive concept.

FIG. 6 is a block diagram illustrating an electronic device having an image sensor, according to embodiments of the inventive concept.

FIGS. 7 through 11 show examples of multimedia devices, to which image sensors according to embodiments of the inventive concept can be applied.

FIG. 12 is an exploded perspective view of a display device according to embodiments of the inventive concept.

FIG. 13 is a sectional view schematically illustrating a structure of a unit cell of the display device of FIG. 12.

FIGS. 14 through 16 are plan views exemplarily illustrating color filter arrays according to other embodiments of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

As appreciated by the present inventive entity, devices and methods of forming devices according to various embodiments described herein may be embodied in microelectronic devices such as integrated circuits, wherein a plurality of devices according to various embodiments described herein are integrated in the same microelectronic device. Accordingly, the cross-sectional view(s) illustrated herein may be replicated in two different directions, which need not be orthogonal, in the microelectronic device. Thus, a plan view of the microelectronic device that embodies devices according to various embodiments described herein may include a plurality of the devices in an array and/or in a two-dimensional pattern that is based on the functionality of the microelectronic device.

The devices according to various embodiments described herein may be interspersed among other devices depending on the functionality of the microelectronic device. Moreover, microelectronic devices according to various embodiments described herein may be replicated in a third direction that may be orthogonal to the two different directions, to provide three-dimensional integrated circuits.

Accordingly, the cross-sectional view(s) illustrated herein provide support for a plurality of devices according to various embodiments described herein that extend along two different directions in a plan view and/or in three different directions in a perspective view. For example, when a single active region is illustrated in a cross-sectional view of a device/structure, the device/structure may include a plurality of active regions and transistor structures (or memory cell structures, gate structures, etc., as appropriate to the case) thereon, as would be illustrated by a plan view of the device/structure.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of this specification and the relevant art and will not be interpreted in an idealized or overly formal sense unless expressly so defined herein.

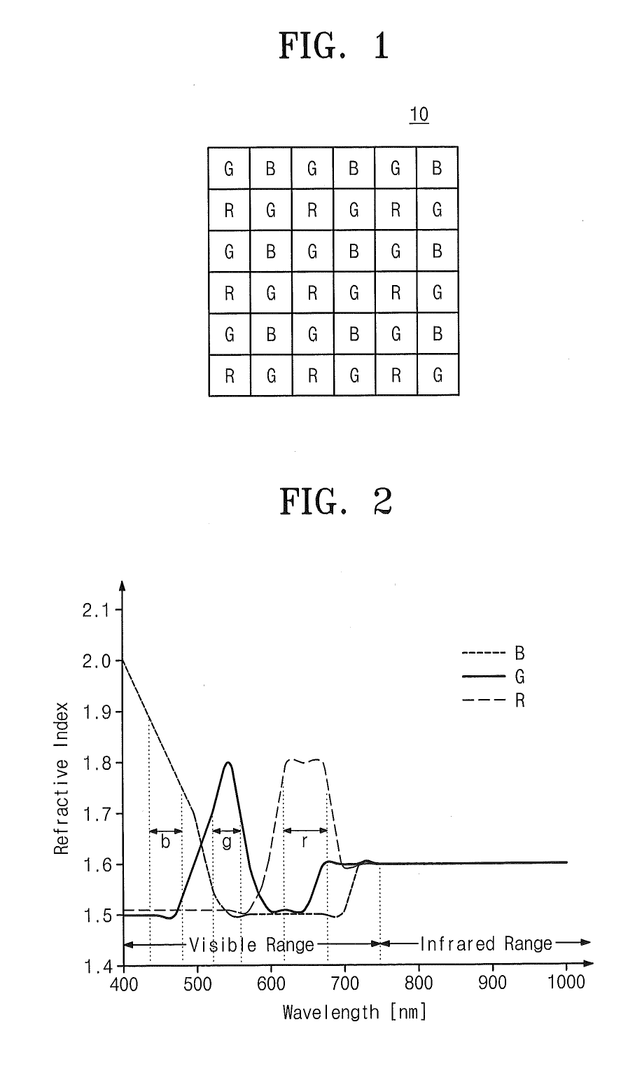

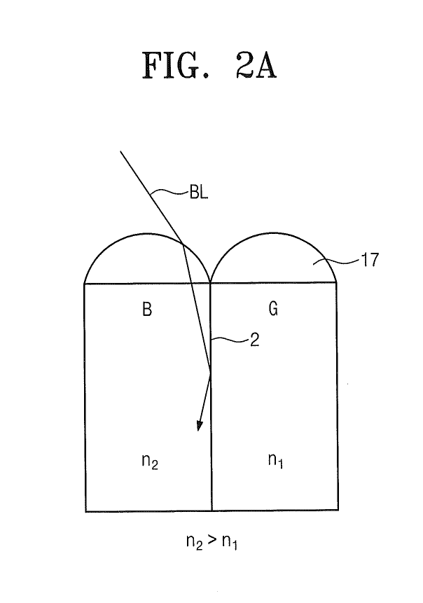

FIG. 1 is a plan view illustrating a color filter array according to embodiments of the inventive concept. FIG. 2 is a graph showing refractive index characteristics of color filters over a range of wavelengths of light, according to embodiments of the inventive concept.

Referring to FIGS. 1 and 2, a color filter array 10 may include a plurality of color filters R, G, and B. An arrangement of the color filters B, G, and R may be variously modified. For example, the color filters B, G, and R may include a first color filter B, a second color filter G, and a third color filter R. In general, a color filter allows light within a given wavelength range, referred to as the passband, to pass through the filter, and attenuates light having wavelengths outside the passband.

The first color filter B may be configured in such a way that light that has a wavelength corresponding to a blue color is allowed to pass therethrough. The second color filter G may be configured in such a way that light that has a wavelength corresponding to a green color is allowed to pass therethrough. The third color filter R may be configured in such a way that light that has a wavelength corresponding to a red color is allowed to pass therethrough. The color filters B, G, and R may be arranged to form a Bayer pattern.

The refractive index of a substance is a function of the wavelength of light passing therethrough. In other words, an object may have a refractive index that varies base on a wavelength of incident light. According to embodiments of the inventive concept, each of the color filters B, G, and R may be configured in such a way that, for a light with a wavelength corresponding to the color thereof, a refractive index of the color filter can be higher than those of other color filters for light within a range of wavelengths that are passed by the color filter. For example, in a blue wavelength range b of about 435-480 nm, the first color filter B may be configured to have a refractive index that is higher than the refractive indices of the second and third color filters G and R for light having wavelengths within the blue wavelength range b, as shown in FIG. 2. Similarly, in a green wavelength range g of about 520-550 nm, the second color filter G may be configured to have a refractive index that is higher than the refractive indices of the first and third color filters B and R for light having wavelengths within the green wavelength range g. In a red wavelength range r of about 620-680 nm, the third color filter R may be configured to have a refractive index that is higher than the refractive indices of the first and second color filters B and G for light having wavelengths within the red wavelength range r. In some embodiments, in a wavelength range corresponding to its own color, each of the color filters B, G, and R may have a refractive index of about 1.7 or higher or of about 1.8 or higher. In some embodiments, in a wavelength range corresponding to its own color, each of the color filters B, G, and R may have a refractive index that is about 0.2 or 0.3 higher than the refractive index of the color filter experienced by light outside its own color.

When light propagates through a material having a refractive index higher than that of a neighboring object, propagation path thereof can be confined within an internal region of the material with the higher refractive index due to the effect of total internal reflection (TIR).

Total internal reflection between adjacent pixels is illustrated in FIG. 2A. Referring to FIG. 2A, two adjacent color filters B and G are illustrated. The color filter B generally allows blue light to pass and attenuates other colors of light, while the color filter G generally allows green light to pass and attenuates other colors of light. A microlens 17 is provided on each of the color filters B, G. The color filter B has an index of refraction n2 with respect to blue light incident thereon, while the color filter G has an index of refraction n1 with respect to blue light incident thereon. The index of refraction n2 of the blue color filter B is greater than the index of refraction n1 of the green color filter.

When a ray of blue light BL is directed into the blue color filter B by one of the microlenses 17, the ray BL may strikc the interface 2 between the blue color filter B and the green color filter G. Depending on the angle of incidence at which the ray BL strikes the interface 2 and the difference in refractive indices n2 and n1, the ray BL may internally reflect off of the interface 2 so that the ray BL stays within the blue color filter B, thereby reducing crosstalk between adjacent pixels.

Because of this property of light propagation, the use of the color filters, each of which has a refractive index higher than those of the others displaying different colors therefrom, in a wavelength range corresponding to its own color, may allow an incident light to propagate through a desired one of the color filters while reducing crosstalk between neighboring pixels due to diffraction. Further, in a wavelength range of visible light, when each of the color filters B, G, and R can allow light with a wavelength corresponding to its own color to pass therethrough, it is possible to realize clearer images. However, if light with an undesired wavelength is incident into each color filter (for example, from a neighboring color filter), an image sensor or a display device may suffer from deterioration in image quality. By contrast, according to example embodiments of the inventive concept, since the undesired optical effects such as diffraction between the color filters can be reduced, it is possible to prevent or reduce the deterioration in image quality. Further, since each color filter is configured to allow light with desired color to pass therethrough, it is possible to increase transmittance of the color filter array.

In certain embodiments, in a wavelength range of infrared light, the color filters B, G, and R may be configured to have substantially the same refractive index. When in the infrared range there is a difference in refractive index between the color filters B, G, and R, a larger amount of light may be incident into a pixel with higher refractive index, compared to other pixels, and this may lead to a difference in color sensitivity of the image sensor or the display device and a consequent deterioration in image quality. However, in the case where the color filters B, G, and R have a similar refractive index in the infrared range as described above, these problems can be reduced.

The refractive index suitable for each of the color filters B, G, and R may be achieved by adjusting contents of materials contained in the color filters B, G, and R. For example, zinc sulfide (ZnS), titanium oxide (TiO₂), zinc oxide (ZnO), or zirconium oxide (ZrO₂) having a refractive index of 1.8 or higher and silicon oxide (SiO₂) having a refractive index of 1.5 or lower may be used to realize the desired refractive indexes for the color filters B, G, and R. In certain embodiments, the refractive indexes for the color filters B, G, and R may be controlled by preparing nano-sized structures made of, for example, the afore-enumerated materials and adding them into the color filters B, G, and R with desired contents. Further, the color filters B, G, and R may include at least one of various additive agents, such as organic resins, inorganic resins, organic binders, inorganic binders, organic-inorganic hybridized resins and binders, radical polymers, radical initiators, or pigments. A content ratio between additive agents having high and low refractive indexes may be controlled to allow the color filters B, G, and R to have refractive indexes suitable for their own colors.

The color filter array 10 may be applied to realize an image sensor.

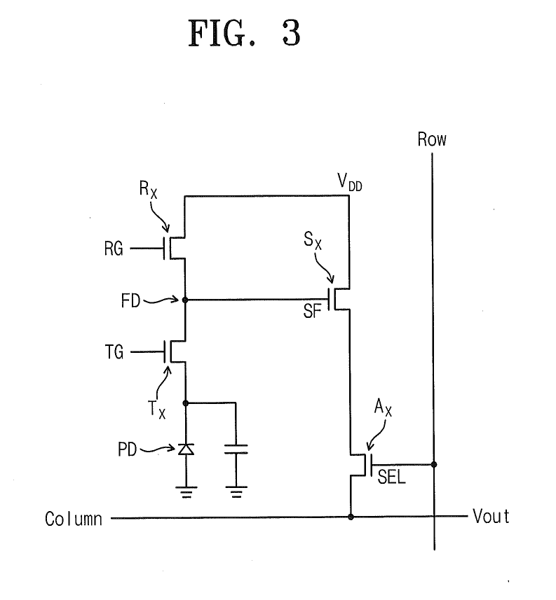

FIG. 3 is a circuit diagram of an image sensor according to example embodiments of the inventive concept.

Referring to FIG. 3, the image sensor may include a plurality of unit pixels, each of which includes a photoelectric conversion region PD, a transfer transistor Tx, a source follower transistor Sx, a reset transistor Rx, and a selection transistor Ax. The transfer transistor Tx, the source follower transistor Sx, the reset transistor Rx, and the selection transistor Ax may include a transfer gate TG, a source follower gate SF, a reset gate RG, and a selection gate SEL, respectively. A photoelectric conversion portion may be provided in the photoelectric conversion region PD. The photoelectric conversion portion may be a photodiode including an n-type impurity region and a p-type impurity region. The transfer transistor Tx may include a drain region serving as a floating diffusion region FD. The floating diffusion region FD may also serve as a source region of the reset transistor Rx. The floating diffusion region FD may be electrically connected to the source follower gate SF of the source follower transistor Sx. The source follower transistor Sx may be connected to the selection transistor Ax. The reset transistor Rx, the source follower transistor Sx, and the selection transistor Ax may be shared by adjacent pixels, and this makes it possible to increase an integration density of the image sensor.

Hereinafter, an operation of the image sensor will be described with reference to FIG. 3. Firstly, when in a light-blocking state, a power voltage VDD may be applied to a drain region of the reset transistor Rx and a drain region of the source follower transistor Sx to discharge electric charges from the floating diffusion region FD. Thereafter, if the reset transistor Rx is turned-off and external light is incident into the photoelectric conversion region PD, electron-hole pairs may be generated in the photoelectric conversion region PD. Holes may be moved toward the p-type doped region of the photoelectric conversion region PD, and electrons may be moved toward and accumulated in the n-type doped region of the photoelectric conversion region PD. If the transfer transistor Tx is turned on, the electrons may be transferred to and accumulated in the floating diffusion region FD. A change in amount of the accumulated electrons may lead to a change in gate bias of the source follower transistor Sx, and this may lead to a change in source potential of the source follower transistor Sx. Accordingly, if the selection transistor Ax is turned on, an amount of the electrons may be read out as a signal to be transmitted through a column line.

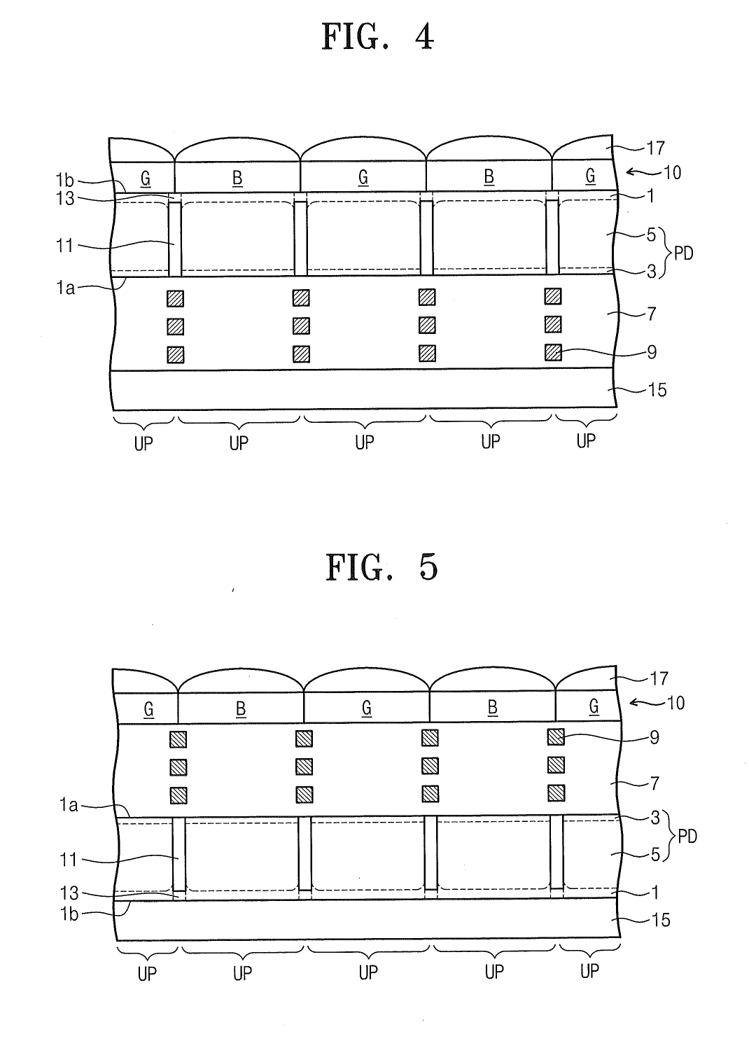

FIG. 4 is a sectional view of an image sensor according to example embodiments of the inventive concept.

Referring to FIG. 4, a device isolation layer 11 may be provided on a substrate 1 to define a plurality of unit pixel regions UP. The substrate 1 may include a first surface 1a and a second surface 1b facing each other. The substrate 1 may be doped to have, for example, a conductivity type of a p-type. A photoelectric conversion part PD may be provided in each pixel region UP of the substrate 1. The photoelectric conversion part PD may include a photo diode including a first impurity region 3 and a second impurity region 5. The first impurity region 3 may be doped to have, for example, a conductivity type of the p-type. The second impurity region 5 may be doped to have, for example, a conductivity type of an n-type. A third impurity region 13 may be disposed between the device isolation layer 11 and the second surface 1b. The third impurity region 13 may be doped to have, for example, a conductivity type of the p-type. The third impurity region 13 may have a doping concentration that is higher than that of the substrate 1. The presence of the third impurity region 13 may contribute to an electric separation between the unit pixel regions UP. Interlayered insulating layers 7 and interconnection lines 9 may be provided on the first surface 1a. Although not shown, the transistors Tx, Sx, Ax, and Rx described with reference to FIG. 3 may be disposed on the first surface 1a to control operations of detecting and transferring electric charges to be produced in the photoelectric conversion part PD. A protection layer 15 may be provided below the interlayered insulating layers 7. The protection layer 15 may be a passivation layer and/or a supporting substrate. A color filter array 10 may be provided on the second surface 1b. The color filter array 10 may be configured to have the features described with reference to FIGS. 1 and 2. A micro lens array 17 may be provided on the color filter array 10. The color filter array 10 may be configured to reduce undesired optical effects (e.g., diffraction and cross-talk) from occurring therein or between adjacent ones of the pixel regions UP. Further, by using the color filter array 10, it is possible to improve optical transmittance of the color filters B, G, and R and consequently improve light sensitivity of the image sensor. The image sensor of FIG. 4 may be configured to serve as a back-side illuminated image sensor.

FIG. 5 is a sectional view of an image sensor according to other example embodiments of the inventive concept.

Referring to FIG. 5, the interlayered insulating layers 7 and the interconnection lines 9 may be provided on the first surface 1a of the substrate 1. The color filter array 10 and the micro lens array 17 may be sequentially stacked on the interlayered insulating layer 7. The protection layer 15 may be provided on the second surface 1b of the substrate 1. The image sensor of FIG. 5 may be configured to serve as a front-side illuminated image sensor. Except for this difference, the image sensor of FIG. 5 may be similar to that of FIG. 4.

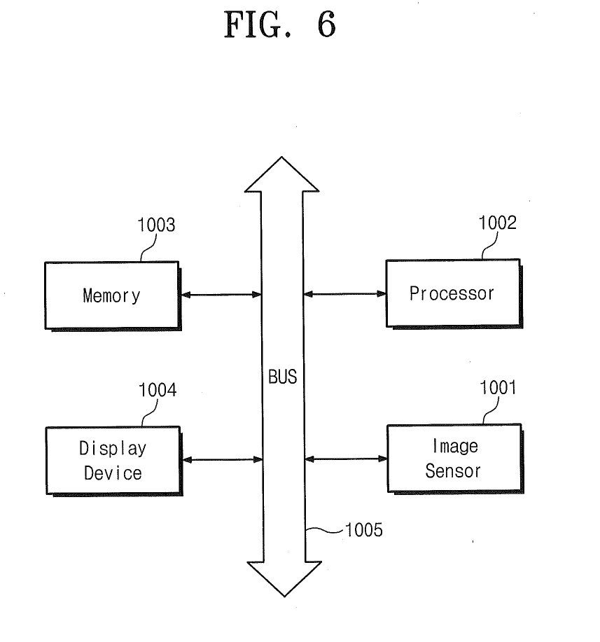

FIG. 6 is a block diagram illustrating an electronic device having an image sensor, according to example embodiments of the inventive concept. The electronic device may be any of various types of devices, such as a digital camera or a mobile device, for example. Referring to FIG. 6, an illustrative digital camera system includes an image sensor 1001, a processor 1002, a memory 1003, a display 1004 and a bus 1005. As shown in FIG. 6, the image sensor 1001 captures an external image under control of the processor 1002, and provides the corresponding image data to the processor 1002 through the bus 1005. The processor 1002 may store the image data in the memory 1003 through the bus 1005. The processor 1002 may also output the image data stored in the memory 1003, e.g., for display on the display device 1004.

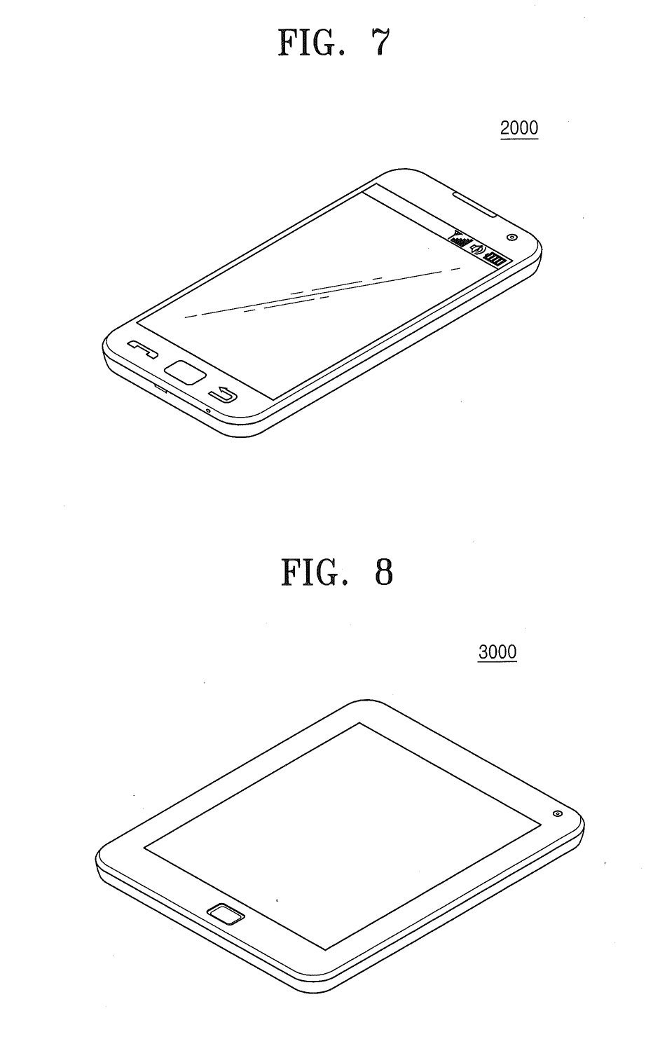

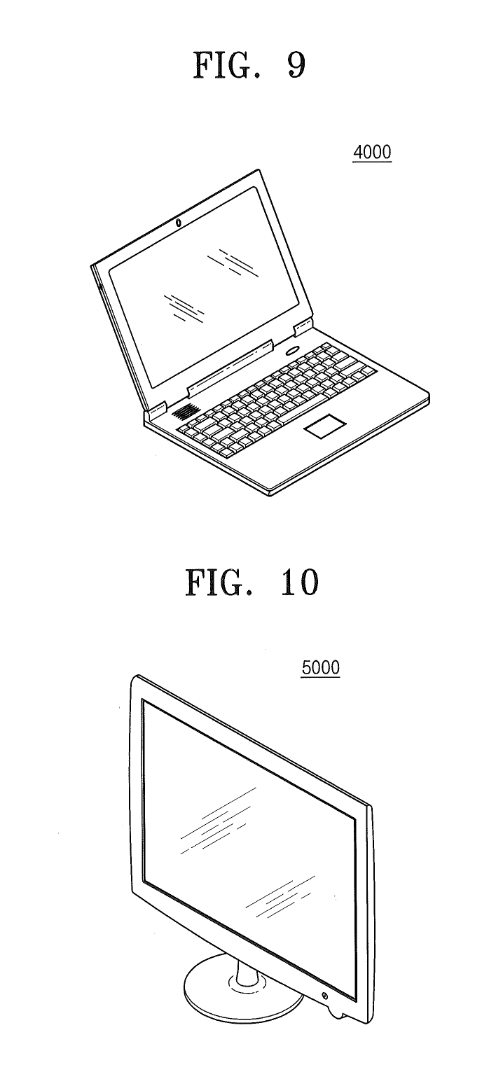

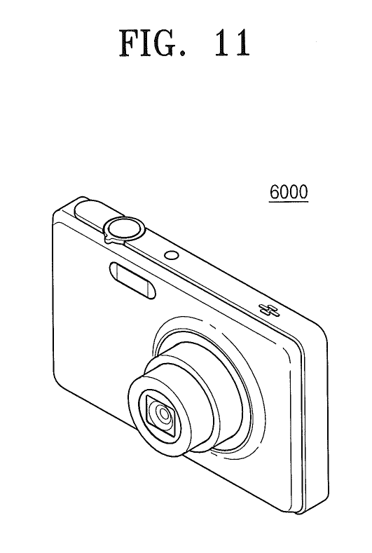

FIGS. 7 through 11 show examples of multimedia devices, to which image sensors according to example embodiments of the inventive concept can be applied. Image sensors according to example embodiments of the inventive concept can be applied to a variety of multimedia devices with an imaging function. For example, image sensors according to example embodiments of the inventive concept may be applied to a mobile phone or a smart phone 2000 as exemplarily shown in FIG. 7, to a tablet PC or a smart tablet PC 3000 as exemplarily shown in FIG. 8, to a laptop computer 4000 as exemplarily shown in FIG. 9, to a television set or a smart television set 5000 as exemplarily shown in FIG. 10, and to a digital camera or a digital camcorder 6000 as exemplarily shown in FIG. 11.

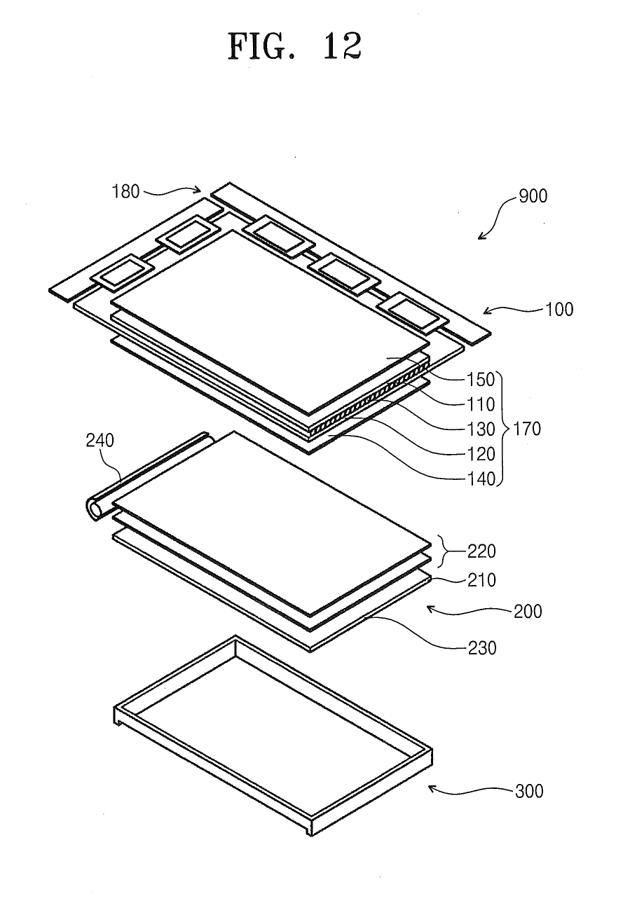

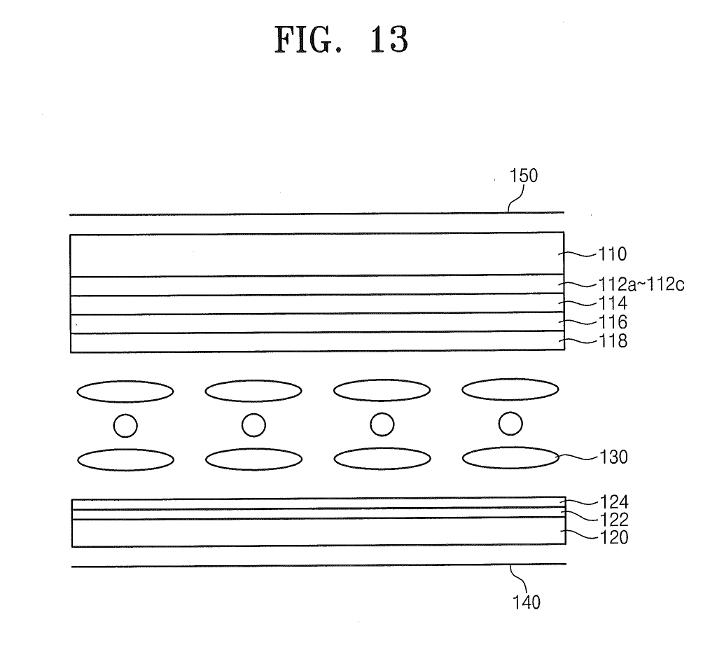

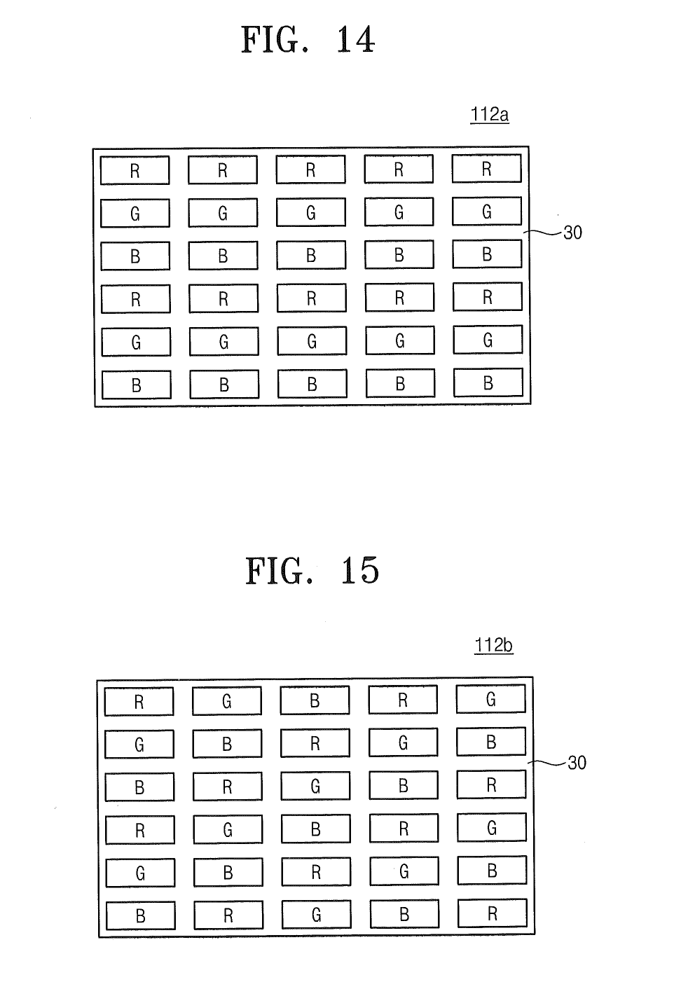

FIG. 12 is an exploded perspective view of a display device according to example embodiments of the inventive concept, and FIG. 13 is a sectional view schematically illustrating a structure of a unit cell of the display device of FIG. 12. FIGS. 14 through 16 are plan views exemplarily illustrating color filter arrays according to other example embodiments of the inventive concept.

Referring to FIGS. 12 and 13, a display device 900 may include a display unit 100 for displaying images, a backlight assembly 200 providing light to the display unit 100, and a mold frame 300 containing the display unit 100 and the backlight assembly 200.

The display unit 100 may include a display panel 170 displaying images and a driver circuit part 180 providing a driving signal (e.g., display information) to the display panel 170.

The display panel 170 may include a color filter substrate 110, a TFT substrate 120, and a display layer 130 provided between the color filter substrate 110 and the TFT substrate 120. In certain embodiments, the color filter substrate 110 may serve as a first substrate for realizing color, while the TFT substrate 120 may serve as a second substrate, which is provided to face the color filter substrate 110, and on which a switching device (e.g., TFT) is integrated. The display layer 130 may be a liquid crystal layer, an electrowetting layer, or an electrophorectic layer. In certain embodiments, the display device 900 may be a liquid crystal display device using the liquid crystal layer as the display layer 130.

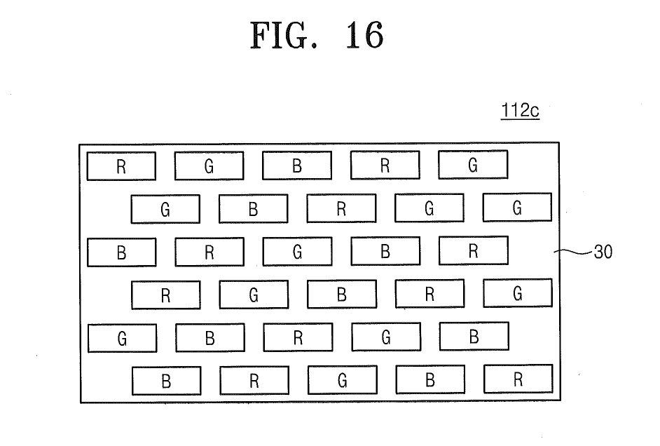

A color filter array 112a, 112b, and 112c and a common electrode 116 may be stacked on the color filter substrate 110, and color pixels for realizing color are provided in the color filter array 112a, 112b, and 112c and the common electrode 116 may serve as a first electrode. In the case where the display layer 130 is a liquid crystal layer, an alignment layer 118 may be provided on the common electrode 116 to align a direction of liquid crystal molecules to a desired direction. In the color filter array 112a, 112b, and 112c, arrangement of the color filters B, G, and R may be variously changed as shown in FIGS. 14 through 16. For example, as shown in FIG. 14, first color filters B, second color filters G, and third color filters R may be arranged along a row direction to form a first row, a second row, and a third row, and the first to third rows may be sequentially and repeatedly disposed in a column direction. As shown in FIG. 15, first color filters B, second color filters G, and third color filters R may be arranged along a diagonal direction to form first, second, and third diagonal groups, which may be sequentially and repeatedly disposed. As shown in FIG. 16, the color filters B, G, and R may be disposed to form a honeycomb structure. The color filters B, G, and R may be spaced apart from each other by a black matrix 30.

The TFT substrate 120 may include thin-film transistors (TFTs; not shown), capacitors (not shown), gate and data lines (not shown), and pixel electrodes 122. Each of the TFTs may serve as a switching device of each pixel, and the gate and data lines may connect the TFTs arranged in a matrix form, and the pixel electrode 122 may serve as a second electrode for producing an electric field along with the common electrode 116 or the first electrode. Each of the TFTs may include a source electrode, a drain electrode, and a gate electrode, and a data signal, one of the driving signals, may be selectively transferred from the source electrode to the pixel electrode via the drain electrode, in response to a gate signal, one of the driving signals. Here, the gate electrode may be provided below the source and drain electrodes (for example, in a bottom gate manner). A protection or passivation layer 124 may be coated on a top surface of the TFT substrate 120 to protect the switching device and the pixel electrode 122 against external scratching or pollution. In certain embodiments, the common electrode 116 and the pixel electrode 122 may be formed of a transparent conductive layer (e.g., an indium-tin-oxide (ITO) layer). Polarizers 140 and 150 may be provided below the TFT substrate 120 and on the color filter substrate 110 to realize a selective transmission of light with a specific polarization.

The driver circuit part 180 may be provided in a neighboring region of the TFT substrate 120 and may include a driver IC or chip. In example embodiments, the driver IC or chip may be mounted on a printed circuit board (PCB) using a surface mounting technology. The use of the surface mounting technology allows the driver circuit part 180 to have small thickness and high density. In other example embodiments, the driver IC or chip may be provided in the form of a tape carrier package (TCP) and may be used to connect the printed circuit board to the TFT substrate 120.

A backlight assembly 200 may be provided below the display unit 100 to supply light to the display panel 170. The backlight assembly 200 may include a light source 240 producing light, a waveguide 210 allowing the light produced by the light source 240 to be incident into the display unit 100 in the form of a plane wave, a light collecting sheet structure 220 for improving light-collection efficiency of light incident into the display unit 100, and a reflector 230 for reflecting leak light toward the display unit 100.

If a driving signal is applied to the afore-described display device 900 through the driver circuit part 180, an electric field may be produced between the pixel electrode 122 and the common electrode 116, and moreover, in the case that the display layer 130 is the liquid crystal layer, alignment of liquid crystal molecules in the display layer 130 may be controlled by the electric field. This means that transmittance of the TFT substrate 120 can be controlled by adjusting direction and/or magnitude of the electric field. The light may propagate through the common electrode 116 and the color filter array 112. Here, since the color filter array 112 has increased transmittance as described with reference to FIGS. 1 and 2, the display device 900 can have a clear image quality.

According to example embodiments of the inventive concept, the color filter array may include color filters, each of which is configured to have a refractive index that is higher than those of the others displaying different colors therefrom, in a wavelength range corresponding to its own color. The use of the color filter array makes it possible to suppress/reduce undesired optical effects (e.g., diffraction), in a wavelength range corresponding to its own color.

In the case that the color filter array is used for an image sensor, a cross-talk problem between adjacent pixels can be reduced in the image sensor.

In the case that the color filter array is used for a display device, the display device can be configured to have a clear image quality.

While example embodiments of the inventive concepts have been particularly shown and described, it will be understood by one of ordinary skill in the art that variations in form and detail may be made therein without departing from the spirit and scope of the attached claims.

What is claimed is:

1. A color filter array comprising a plurality of color filters, each of which is configured to pass a respective color of light and has a refractive index for light of the respective color it passes that is higher than refractive indices of adjacent ones of the color filters for light of the respective color.

2. The color filter array of claim 1, wherein the color filters have substantially the same refractive index for light in a wavelength range corresponding to infrared light.

3. The color filter array of claim 1, wherein a respective one of the color filters has a refractive index of about 1.8 or higher, for light in a wavelength range corresponding to a color of the respective color filter.

4. The color filter of claim 1, wherein a respective one of the color filters has a first refractive index for light having the color of the respective one of the color filters that is at least about 0.2 greater than a second refractive index of the respective one of the color filters for light having a color that is different from the color of the respective one of the color filters.

5. The color filter array of claim 1, wherein the color filters contain at least one of zinc sulfide (ZnS), titanium oxide (TiO₂), zinc oxide (ZnO), or zirconium oxide (ZrO₂).

6. An image sensor, comprising:
the color filter array of claim 1; and
a plurality of photoelectric conversion parts, which are provided on the color filter array, wherein each of the plurality of photoelectric conversion parts faces a corresponding one of the color filters.

7. The image sensor of claim 6, further comprising an interlayer insulating layer and interconnection lines provided on the plurality of photoelectric conversion parts opposite the color filter array.

8. The image sensor of claim 6, further comprising an interlayer insulating layer and interconnection lines provided between the color filter array and the plurality of photoelectric conversion parts.

9. The image sensor of claim 6, further comprising a micro lens array on the color filter array opposite the plurality of photoelectric conversion elements.

10. The image sensor of claim 6, wherein the color filters have a similar refractive index for light having a wavelength in an infrared range.

11. The image sensor of claim 6, wherein each of the color filters has a refractive index of about 1.8 or higher, in a wavelength range corresponding to its own color.

12. A display device comprising:
the color filter array of claim 1; and
a display layer on the color filter array.

13. A color filter array, comprising:
a first color filter of a first color;
a second color filter of a second color; and
a third color filter of a third color,
wherein the first color filter has a refractive index for light corresponding to the first color that is higher than the refractive indices of the second and third color filters for light corresponding to the first color.

14. The color filter array of claim 13, wherein the second color filter has a refractive index for light of the second color that is higher than the refractive indices of the first and third color filters for light of the second color.

15. The color filter array of claim 13, wherein the third color filter has a refractive index for light of the third color that is higher than the refractive indices of the first and second color filters for light of the third color.

16. The color filter array of claim 13, wherein the first, second, and third color filters have substantially the same refractive index for light in an infrared wavelength range.

17. A color filter array comprising:
a plurality of color filters arranged in an array;
wherein a first one of the plurality of color filters has a first passband and a first refractive index for light within the first passband that is higher than a second refractive index of a second one of the plurality of color filters for light within the first passband, wherein the second one of the plurality of color filters has a second passband that is different from the first passband.

18. The color filter array of claim 17, wherein each of the color filters has a refractive index of about 1.8 or higher, for light in a wavelength range corresponding to its passband.

19. The color filter array of claim 17, wherein the first refractive index for light having a wavelength within the first passband is at least about 0.2 greater than the second refractive index for light having a wavelength within the first passband.

20. The color filter array of claim 17, wherein the color filters have substantially the same refractive index for light in an infrared wavelength range.
